(19) United States
(12) Patent Application Publication
(10) Pub. No.: US 2007/0174997 A1
(43) Pub. Date: Aug. 2, 2007

(54) Suspension hinge

(75) Inventors: Sheng-Nan Lu, Taipei Hsien (TW); Yao-Tsung Chan, Taipei Hsien (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SHIN ZU SHING CO., LTD., Shulin City (TW)

(21) Appl. No.: 11/341,267

(22) Filed: Jan. 27, 2006

(51) Int. Cl. E05D 3/10

(52) U.S. Cl. 16/367

(57) ABSTRACT

A suspension hinge that connects a liquid crystal display (LCD) to a roof of a vehicle has a central bracket, a first shaft assembly, a second shaft assembly and a third shaft assembly. The central bracket has a connecting wing, a first wing and a second wing. The first and second wings are oppositely formed perpendicularly on the connecting wing. The first and second shaft assemblies are respectively mounted pivotally on the first and second wings to allow the LCD to be opened and closed in relative to the roof. The third shaft assembly is mounted pivotally on the connecting wing to allow the LCD to rotate in relative to the roof. Then the viewing angle of the LCD can be adjusted easily.

### BACKGROUND OF THE INVENTION

1. Field of the Invention

The present invention relates to a suspension hinge, especially to a suspension hinge for a suspended liquid crystal display.

2. Description of the Prior Arts

As technology progresses, more and more equipment is used in vehicles such as buses, cars, etc. Liquid crystal displays (LCD) are one of the additional equipment used in vehicles to play movies, digital TV programs, etc. Generally, the LCD is suspended from the roof of a vehicle to allow more passengers to easily see the LCD. The LCD is suspended with a conventional bracket or hinge. However, the conventional bracket or hinge can only attach the LCD to the roof. When the passengers want to change the viewing angle of the LCD, the conventional bracket or hinge either cannot be adjusted from side to side or can only be adjusted by reinstalling the LCD with tools. Therefore, the conventional brackets and hinges do not provide a capability for passengers to adjust the viewing angle of LCDs especially from side to side.

To overcome the shortcomings, the present invention provides a suspension hinge to mitigate or obviate the aforementioned problems.

### SUMMARY OF THE INVENTION

The main objective of the present invention is to provide a suspension hinge that connects a liquid crystal display (LCD) to a roof of a vehicle and allows the LCD to be opened and closed and the viewing angle of the LCD to be adjusted easily. The suspension hinge has a central bracket, a first shaft assembly, a second shaft assembly and a third shaft assembly. The central bracket has a connecting wing, a first wing and a second wing. The first and second wings are oppositely formed perpendicularly on the connecting wing. The first and second shaft assemblies are respectively mounted pivotally on the first and second wings to allow the LCD to be opened and closed in relative to the roof. The third shaft assembly is mounted pivotally on the connecting wing to allow the LCD to rotate in relative to the roof. Then the viewing angle of the LCD can be adjusted easily.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a suspension hinge in accordance with the present invention;

FIG. 2 is an exploded perspective view of the suspension hinge in FIG. 1;

FIG. 3 is another exploded perspective view of the suspension hinge in FIG. 1;

FIG. 4 is an operational side view in partial section of the suspension hinge in FIG. 1 with a roof and a liquid crystal display (LCD);

FIG. 5 is an operational side view in partial section of the suspension hinge in FIG. 1 with the roof and the LCD; and

FIG. 6 is an operational perspective view of the suspension hinge in FIG. 1.

### DETAILED DESCRIPTION OF THE PREFERRED EMBODIMENTS

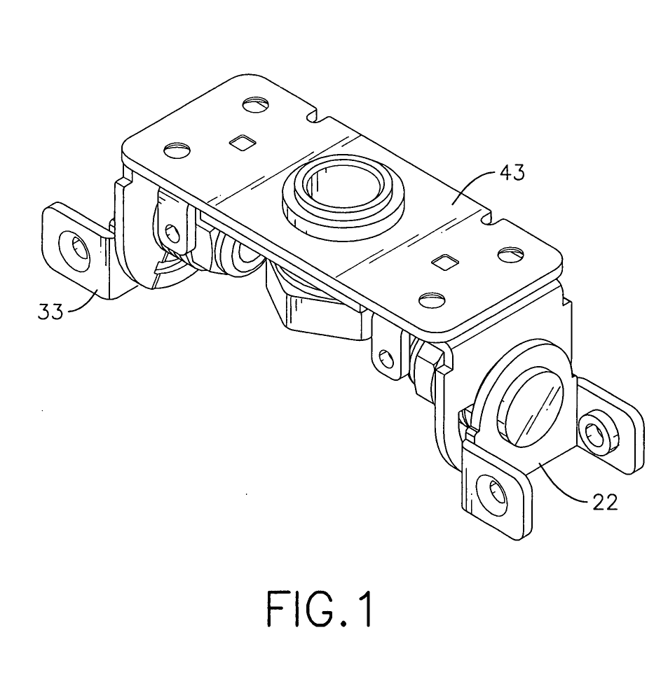

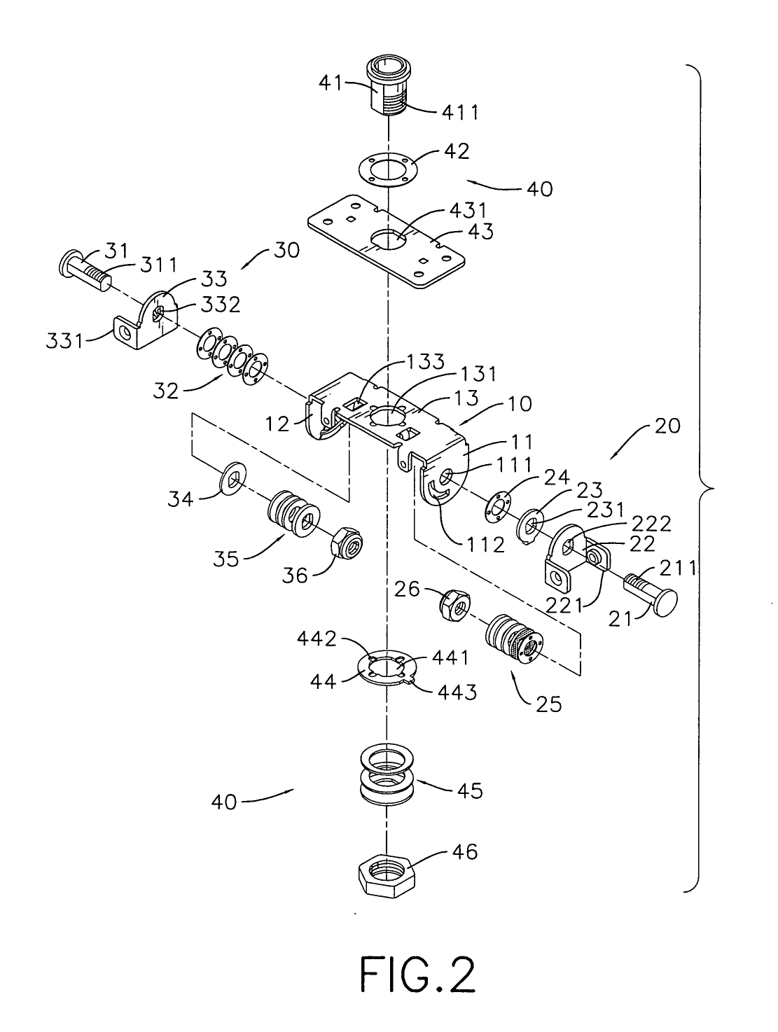

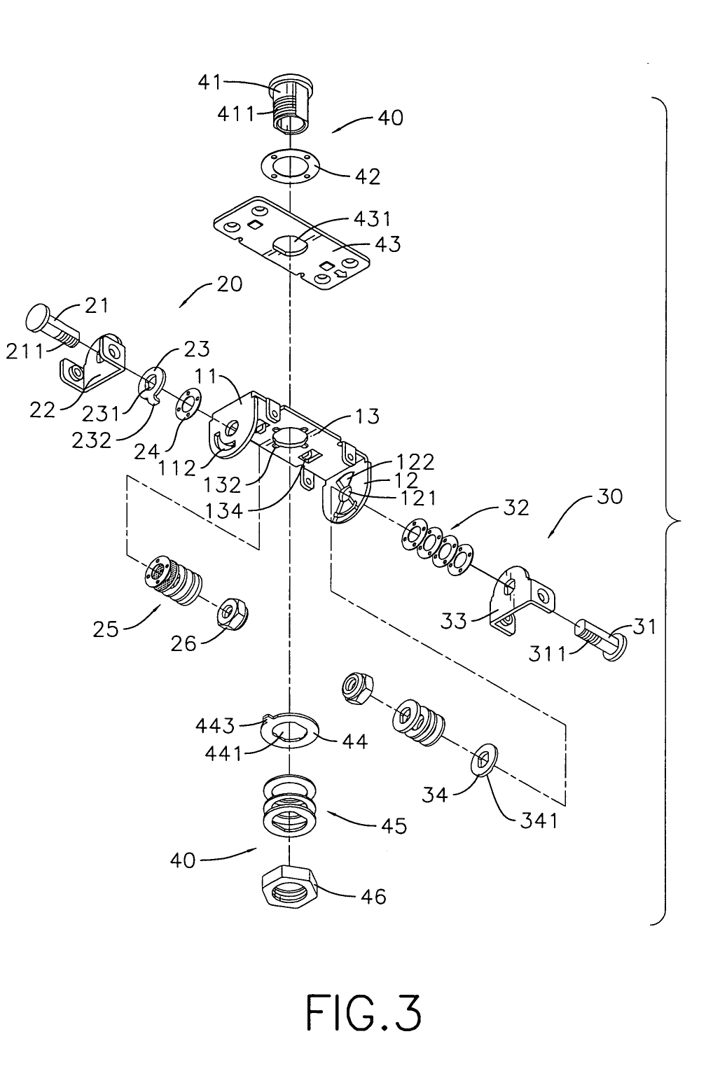

With reference to FIGS. 1-3, a suspension hinge in accordance with the present invention comprises a central bracket (10), a first shaft assembly (20), a second shaft assembly (30) and a third shaft assembly (40).

The central bracket (10) has a connecting wing (13), a first wing (11) and a second wing (12).

The connecting wing (13) has a first end, a second end, a top surface and a bottom surface and may have a central hole (131), multiple positioning protrusions (132), two through holes (133) and two stops (134). The central hole (131) is circular and is formed through the connecting wing (13). The positioning protrusions (132) are formed on the bottom surface of the connecting wing (13) and are adjacent to the central hole (131) of the connecting wing (13). The through holes (133) are formed separately through the connecting wing (13). The stops (134) are formed on the bottom surface of the connecting wing (13) and are respectively adjacent to the through holes (133).

The first wing (11) is formed perpendicularly on the first end of the connecting wing (13), has an inside surface and an outside surface and may have a central hole (111) and a slot (112). The central hole (111) is formed through the first wing (11) and is circular. The slot (112) is formed through the first wing (11) and is crescent.

The second wing (12) is formed perpendicularly on the second end of connecting wing (13), corresponds to the first wing (11), has an inside surface and an outside surface and may have a central hole (121) and multiple detents (122). The inside surface of the second wing (12) faces to the inside surface of the first wing (11). The central hole (121) is formed through the second wing (12) and is circular. The detents (122) are formed in the inside surface of the second wing (12) along the central hole (121) of the second wing (12).

The first shaft assembly (20) is mounted pivotally on the first wing (11) of the central bracket (10) and has a first rod (21), a first bracket (22), a first spacer (24), a first biasing member (25), a first fastener (26) and an optional limiting element (23).

The first rod (21) is mounted through the first wing (11) of the central bracket (10), may be non-circular, may extend through the central hole (111) of the first wing (11) of the central bracket (10), has a distal end and may have a thread (211). The thread (211) is formed around the first rod (21) adjacent to the distal end of the first rod (21).

The first bracket (22) is mounted securely on the first rod (21), is mounted near the outside surface of the first wing (11) of the central bracket (10) and may have two sides, two securing wings (221) and a through hole (222). The securing wings (221) are oppositely formed respectively on the sides of the first bracket (22). The through hole (222) is formed through the first bracket (22) and may be non-circular to be mounted securely on the first rod(21).

The first spacer (24) is mounted around the first rod (21) and may be near the outside surface of the first wing (11) of the central bracket (10). The first biasing member (25) is mounted around the first rod (21) and may be near the inside surface of the first wing (11) of the central bracket (10). The first fastener (26) is mounted securely on the distal end of the first rod (21) and may be a nut to screw on the thread (211) of the first rod (21).

The limiting element (23) is mounted securely on the first rod (21) and has an edge, a through hole (231) and a stop (232). The through hole (231) is formed through the limiting element (23) and may be non-circular to be mounted securely on the first rod (21). The stop (232) is formed axially on the edge of the limiting element (23), extends toward the first wing (11) of the central bracket (10), corresponds to and is mounted slidably in the slot (112) of the first wing (11) of the central bracket (10) to limit the rotating angle of the first rod (21) and the first bracket (22) and may be mounted between the first bracket (22) and the first spacer (24).

The second shaft assembly (30) is mounted pivotally on the second wing (12) of the central bracket (10) and has a second rod (31), a second bracket (33), multiple second spacers (32), a second biasing member (35), a second fastener (36) and an optional positioning element (34).

The second rod (31) is mounted through the second wing (12) of the central bracket (10), may be non-circular, may extend through the central hole (121) of the second wing (12) of the central bracket (10), has a distal end and may have a thread (311). The thread (311) is formed around the second rod (31) adjacent to the distal end of the second rod (31).

The second bracket (33) is mounted securely on the second rod (31), is mounted near the outside surface of the second wing (12) of the central bracket (10) and may have two sides, two securing wings (331) and a through hole (332). The securing wings (331) are formed respectively on the sides of the second bracket (33). The through hole (332) is formed through the second bracket (33) and may be non-circular to be mounted securely on the second rod (31).

The second spacers (32) are mounted around the second rod (31) and may be near the outside surface of the second wing (12) of the central bracket (10). The second biasing member (35) is mounted around the second rod (31) and may be near the inside surface of the second wing (12) of the central bracket (10). The second fastener (36) is mounted securely on the distal end of the second rod (31) and may be a nut to screw on the thread (311) of the second rod (31).

The positioning element (34) is mounted securely on the second rod (31), is mounted against the inside surface of the second wing (12) of the central bracket (10) and has an inside surface and multiple positioning protrusions (341). The inside surface of the positioning element (34) faces to the inside surface of the second wing (12) of the central bracket (10). The positioning protrusions (341) are formed on the inside surface of the positioning element (34) and corresponds to and selectively engages the detents (122) of the second wing (12) of the central bracket (10) to selectively position the second rod (31) and the second bracket (33).

The third shaft assembly (40) is mounted pivotally on the connecting wing (13) of the central bracket (10) and has a third rod (41), a securing element (43), a third spacer (42), a third biasing member (45), a third fastener (46) and an optional positioning-limiting element (44).

The third rod (41) is mounted through the connecting wing (13) of the central bracket (10), may be non-circular, may extend through the central hole (131) of the connecting wing (13) of the central bracket (10, has a distal end and may have a thread (411). The thread (411) is formed around the third rod (41) adjacent to the distal end of the third rod (41).

The securing element (43) of the third shaft assembly (40) is mounted securely on the third rod (41), is mounted near the top surface of the connecting wing (13) of the central bracket (10) and may have a through hole (431). The through hole (431) is formed through the securing element (43) and may be non-circular to be mounted securely on the third rod (41).

The third spacer (42) is mounted around the third rod (41) and may be adjacent to the securing element (43) of the third shaft assembly (40). The third biasing member (45) is mounted around the third rod (41) and may be near the bottom surface of the connecting wing (13) of the central bracket (10). The third fastener (46) is mounted securely on the distal end of the third rod (41) and may be a nut to screw on the thread (411) of the third rod (41).

The positioning-limiting element (44) is mounted securely on the third rod (41) and has a top surface, a bottom surface, an edge, a through hole (441), multiple detents (442) and a stop (443). The top surface of the positioning-limiting element (44) faces to the bottom surface of the connecting wing (13) of the central bracket (10). The through hole (441) is formed through the positioning-limiting element (44) and may be non-circular to be mounted securely on the third rod (41). The detents (442) are formed in the top surface of the positioning-limiting element (44), are adjacent to the through hole (441) of the positioning-limiting element (44) and correspond to and selectively engage the positioning protrusions (132) of the connecting wing (13) of the central bracket (10) to selectively position the third rod (41) and the securing element (43) of the third shaft assembly (40). The stop (443) is formed on the edge of the positioning-limiting element (44) and selectively abuts the stops (134) of the connecting wing (13) of the central bracket (10) to limit the rotating angle of the third rod (41) and the securing element (43) of the third shaft assembly (40).

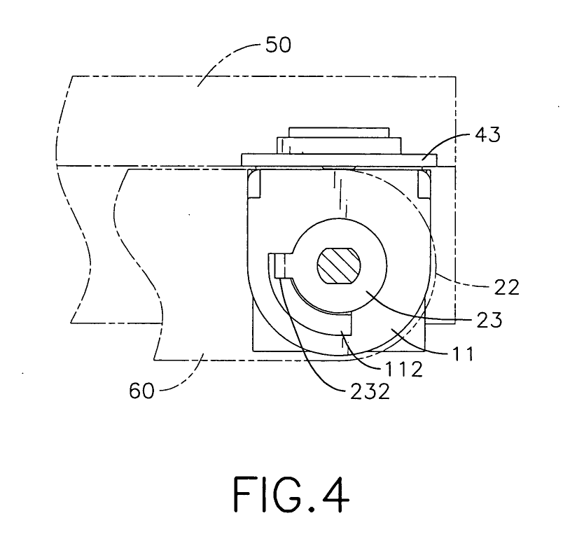

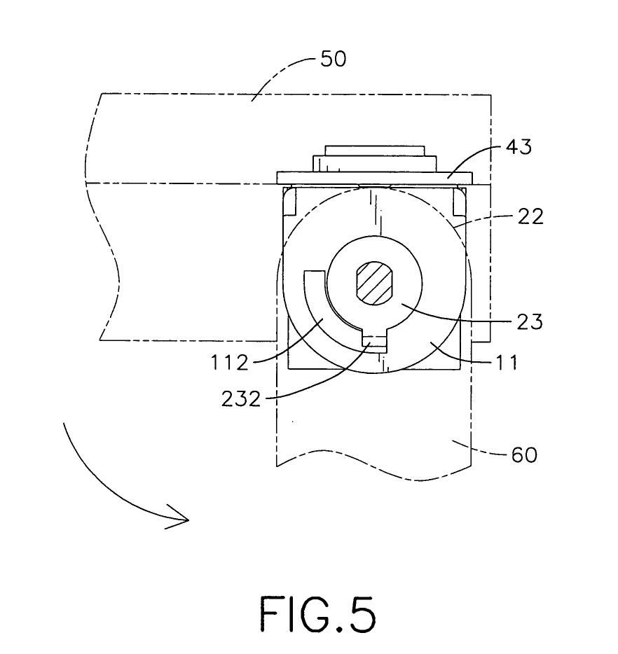

With further reference to FIGS. 4 and 5, the suspension hinge as described is mounted between a roof (50) of a vehicle and a liquid crystal display (LCD) (60). The securing element (43) of the third shaft assembly (40) is attached to the roof(50). The securing wings (221, 331) of the first and second brackets (22, 33) are attached to the LCD (60).

When the LCD (60) is opened in relative to the roof (50), the LCD (60) rotates the first and second brackets (22, 33). Because the first and second brackets (22, 33) is respectively mounted securely on the first and second rods (21, 31), the first and second rods (21, 31) are rotated. The first rod (21) rotates the limiting element (23). Then the stop (232) of the limiting element (23) slides in the slot (112) of the first wing (11) of the central bracket (10). The stop (232) of the limiting element (23) selectively presses against the ends of the slot (112) to limit the rotating angle of the first rod (21). Therefore, the rotating angle of the LCD (60) is also limited. Furthermore, the second rod (31) rotates the positioning element (34). Then the positioning protrusions (341) of the positioning element (34) selectively engage the detents (122) of the second wing (12) of the central bracket (10) to selectively position the second rod (31). Therefore, the LCD (60) is selectively positioned.

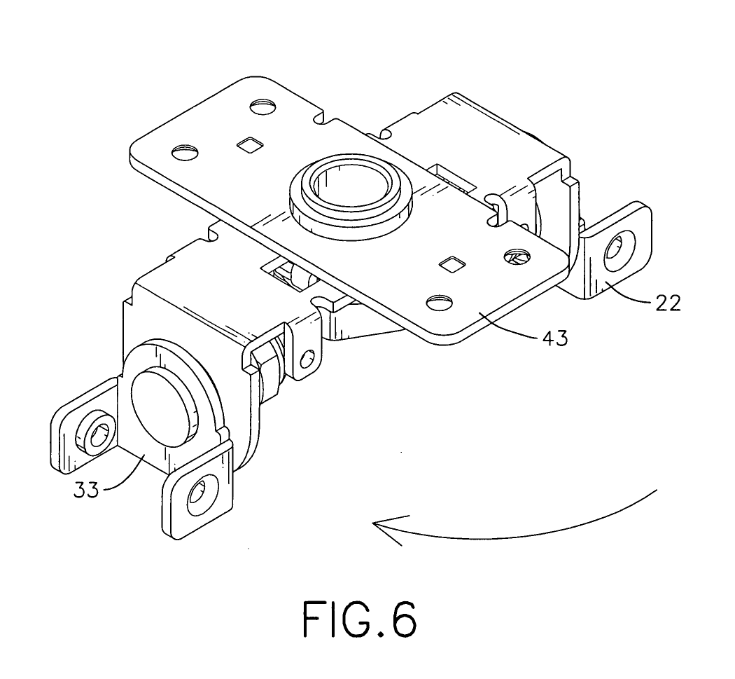

With further reference to FIG. 6, the LCD (60) rotates the securing element (43) of the third shaft assembly (40) when the LCD (60) is rotated in relative to the roof (50). Because the securing element (43) is mounted securely on third rod (41), the third rod (41) is rotated to rotate the positioning-limiting element (44). Then the detents (442) of the positioning-limiting element (44) selectively engage the positioning protrusions (132) of the connecting wing (13) of the central bracket (10) to selectively position the third rod (41). Therefore, the LCD (60) is selectively positioned. Furthermore, the stop (443) of the positioning-limiting element (44) selectively presses against the stops (134) of the connecting wing (13) of the central bracket (10) to limit the rotating angle of the third rod (41). Therefore, the rotating angle of the LCD (60) is also limited.

The suspension hinge as described has numerous advantages. With the first and second shaft assemblies (20, 30), the LCD (60) can be opened in relative to the roof (50). With the third shaft assembly (40), the LCD (60) can be rotated in relative to the roof (50). Therefore, the passengers can open and close the LCD (60) as desired and can adjust the viewing angle of the LCD (60) as desired. Furthermore, the LCD (60) is selectively positioned with the positioning element (34) of the second shaft assembly (30) and the positioning-limiting element (44) of third shaft assembly (40). The rotating angle of the LCD (60) is also limited with the limiting element (23) of the first shaft assembly (20) and the positioning-limiting element (44) of the third shaft assembly (40).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A suspension hinge comprising:
a central bracket having
a connecting wing having a first end, a second end, a top surface and a bottom surface;
a first wing formed perpendicularly on the first end of the connecting wing and having an inside surface and an outside surface; and
a second wing formed perpendicularly on the second end of connecting wing, corresponding to the first wing, having an outside surface and an inside surface that faces to the inside surface of the first wing;
a first shaft assembly mounted pivotally on the first wing of the central bracket and having
a first rod mounted through the first wing of the central bracket and having a distal end;
a first bracket mounted securely on the first rod and mounted near the outside surface of the first wing of the central bracket;
a first spacer mounted around the first rod;
a first biasing member mounted around the first rod; and
a first fastener mounted securely on the distal end of the first rod;
a second shaft assembly mounted pivotally on the second wing of the central bracket and having
a second rod mounted through the second wing of the central bracket and having a distal end;
a second bracket mounted securely on the second rod and mounted near the outside surface of the second wing of the central bracket;
multiple second spacers mounted around the second rod;
a second biasing member mounted around the second rod; and
a second fastener mounted securely on the distal end of the second rod; and
a third shaft assembly mounted pivotally on the connecting wing of the central bracket and having
a third rod mounted through the connecting wing of the central bracket and having a distal end;
a securing element mounted securely on the third rod and mounted near the top surface of the connecting wing of the central bracket;
a third spacer mounted around the third rod;
a third biasing member mounted around the third rod; and
a third fastener mounted securely on the distal end of the third rod.

2. The suspension hinge as claimed in claim 1, wherein
the first wing of the central bracket has a slot formed through the first wing and being crescent;
the second wing of the central bracket has multiple detents formed in the inside surface of the second wing;
the first shaft assembly has a limiting element mounted securely on the first rod and having
an edge; and
a stop formed axially on the edge of the limiting element,
extending toward the first wing of the central bracket, corresponding to and mounted slidably in the slot of the first wing of the central bracket; and
the second shaft assembly has a positioning element mounted securely on the second rod, mounted against the inside surface of the second wing of the central bracket and having
an inside surface facing to the inside surface of the second wing of the central bracket; and
multiple positioning protrusions formed on the inside surface of the positioning element and corresponding to and selectively engaging the detents of the second wing of the central bracket.

3. The suspension hinge as claimed in claim 1, wherein
the connecting wing of the central bracket has
multiple positioning protrusions formed on the bottom surface of the connecting wing;
two through holes formed separately through the connecting wing; and
two stops formed on the bottom surface of the connecting wing and respectively adjacent to the through holes; and
the third shaft assembly has a positioning-limiting element mounted securely on the third rod and having
a top surface facing to the bottom surface of the connecting wing of the central bracket;
a bottom surface;
an edge;
multiple detents formed on the top surface of the positioning-limiting element and corresponding to and selectively engaging the positioning protrusions of the connecting wing of the central bracket; and
a stop formed on the edge of the positioning-limiting element and selectively abutting the stops of the connecting wing of the central bracket.

4. The suspension hinge as claimed in claim 2, wherein
the connecting wing of the central bracket has
multiple positioning protrusions formed on the bottom surface of the connecting wing;
two through holes formed separately through the connecting wing; and
two stops formed on the bottom surface of the connecting wing and respectively adjacent to the through holes; and
the third shaft assembly has a positioning-limiting element mounted securely on the third rod and having
a top surface facing to the bottom surface of the connecting wing of the central bracket;
a bottom surface;
an edge;
multiple detents formed on the top surface of the positioning-limiting element and corresponding to and selectively engaging the positioning protrusions of the connecting wing of the central bracket; and
a stop formed on the edge of the positioning-limiting element and selectively abutting the stops of the connecting wing of the central bracket.

5. The suspension hinge as claimed in claim 4, wherein
the connecting wing of the central bracket has a circular central hole formed through the connecting wing;
the first wing of the central bracket has a circular central hole formed through the first wing;
the second wing of the central bracket has a circular central hole formed through the second wing;
the first rod is non-circular and extends through the central hole of the first wing of the central bracket;
the first bracket has a non-circular through hole formed through the first bracket to be mounted securely on the first rod;
the limiting element of the first shaft assembly has a non-circular through hole formed through the limiting element to be mounted securely on the first rod;
the second rod is non-circular and extends through the central hole of the second wing;
the second bracket has a non-circular through hole formed through the second bracket to be mounted securely on the second rod;
the third rod is non-circular and extends through the central hole of the connecting wing of the central bracket;
the securing element of the third shaft assembly has a non-circular through hole formed through the securing element to be mounted securely on the third rod; and
the positioning-limiting element of the third shaft assembly has a non-circular through hole formed through the positioning-limiting element to be mounted securely on the third rod.

6. The suspension hinge as claimed in claim 1, wherein
the first bracket has
two sides; and
two securing wings oppositely formed respectively on the sides of the first bracket; and
the second bracket has
two sides; and
two securing wings oppositely formed respectively on the sides of the second bracket.

7. The suspension hinge as claimed in claim 5, wherein
the first bracket has
two sides; and
two securing wings oppositely formed respectively on the sides of the first bracket; and
the second bracket has
two sides; and
two securing wings oppositely formed respectively on the sides of the second bracket.

8. The suspension hinge as claimed in claim 1 wherein
the first rod has a thread formed around the first rod adjacent to the distal end of the first rod;
the first fastener is a nut to screw on the thread of the first rod;
the second rod has a thread formed around the second rod adjacent to the distal end of the second rod;
the second fastener is a nut to screw on the thread of the second rod;
the third rod has a thread formed around the third rod adjacent to the distal end of the third rod; and
the third fastener is a nut to screw on the thread of the third rod.

9. The suspension hinge as claimed in claim 7 wherein
the first rod has a thread formed around the first rod adjacent to the distal end of the first rod;
the first fastener is a nut to screw on the thread of the first rod;
the second rod has a thread formed around the second rod adjacent to the distal end of the second rod;
the second fastener is a nut to screw on the thread of the second rod;
the third rod has a thread formed around the third rod adjacent to the distal end of the third rod; and
the third fastener is a nut to screw on the thread of the third rod.

10. The suspension hinge as claimed in claim 1, wherein
the first spacer is mounted near the outside surface of the first wing of the central bracket;
the first biasing member is mounted near the inside surface of the first wing of the central bracket;
the second spacers are mounted near the outside surface of the second wing of the central bracket;
the second biasing member is mounted near the inside surface of the second wing of the central bracket;
the third spacer is mounted adjacent to the securing element of the third shaft assembly; and
the third biasing member is mounted near the bottom surface of the connecting wing of the central bracket.

11. The suspension hinge as claimed in claim 9, wherein
the first spacer is mounted near the outside surface of the first wing of the central bracket;
the first biasing member is mounted near the inside surface of the first wing of the central bracket;
the second spacers are mounted near the outside surface of the second wing of the central bracket;
the second biasing member is mounted near the inside surface of the second wing of the central bracket;
the third spacer is mounted adjacent to the securing element of the third shaft assembly; and
the third biasing member is mounted near the bottom surface of the connecting wing of the central bracket.
